(19) United States
(12) Patent Application Publication
(10) Pub. No.: US 2014/0146394 A1
(43) Pub. Date: May 29, 2014

(54) PERIPHERAL DISPLAY FOR A NEAR-EYE DISPLAY DEVICE

(71) Applicants: Nigel David Tout, Woodinville, WA (US); Steve J. Robbins, Bellevue, WA (US)

(72) Inventors: Nigel David Tout, Woodinville, WA (US); Steve J. Robbins, Bellevue, WA (US)

(21) Appl. No.: 13/688,102

(22) Filed: Nov. 28, 2012

(51) Int. Cl. G02B 27/01

(52) U.S. Cl. CPC G02B 27/017
USPC 359/630

(57) ABSTRACT

Technology is described for a peripheral display for use with a near-eye display device. The peripheral display is positioned by a near-eye support structure of the near-eye display device for directing a visual representation of an object towards a side of an eye area associated with the near-eye display device. The peripheral display has a lower resolution than a resolution of a front display of the near-eye display device. The peripheral display may include a Fresnel structure. The peripheral display may be used for augmented reality, virtual reality and enhanced vision applications.

### BACKGROUND

The field of view of human vision can extend up to about two hundred (200) degrees including human peripheral vision, for example about 100 degrees to the left and 100 degrees to the right of a center of a field of view. A near-eye display (NED) device such as a head mounted display (HMD) device may be worn by a user for an augmented reality (AR) experience or a virtual reality (VR) experience. Typically, a NED is limited to a much smaller field of view than natural human vision provides so that the NED effectively provides no peripheral vision of image data representing an object. The smaller field of view can detract from the augmented reality or virtual reality experience as the user does not perceive the object entering and leaving the field of view of the NED as he would perceive the object entering and leaving his natural sight field of view.

### SUMMARY

The technology provides one or more embodiments of a peripheral display for use with a near-eye display device. An embodiment of a peripheral display for use with a near-eye display device comprises a peripheral display positioned by a near-eye support structure of the near-eye display device for directing a visual representation of an object in peripheral field of view associated with the peripheral display towards a side of an eye area associated with the near-eye display device. The peripheral display has a lower angular resolution than an angular resolution of a front display positioned by the support structure in front of an eye area associated with the near-eye display device.

The technology provides one or more embodiments of a near-eye display device. An embodiment of a near-eye display device comprises a near-eye support structure, a front display positioned by the near-eye support structure to be in front of an eye area associated with the near-eye display device and at least one peripheral display having a lower display resolution than the front display. The at least one peripheral display is positioned by the near-eye support structure at a side position to the front display. An image source is optically coupled to the peripheral display. One or more processors are communicatively coupled to the image source for controlling image data displayed by the at least one peripheral display.

The technology provides one or more embodiments of a method for indicating an object on a peripheral display of a near-eye display device. An embodiment of the method comprises identifying the object as being within a field of view of the peripheral display which is positioned at a side position relative to a front display of the near-eye display device and generating a visual representation of the object based on an angular resolution of the peripheral display. The angular resolution of the peripheral display is lower than an angular resolution of the front display. The method further comprises displaying the visual representation of the object by the peripheral display.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram of an embodiment of a near-eye display device including a peripheral display in an exemplary system environment.

FIG. 1B is a block diagram of another embodiment of a near-eye display device including a peripheral display in an exemplary system environment.

FIG. 1C is a block diagram of yet another embodiment of a near-eye display device including a peripheral display in an exemplary system environment.

FIG. 2A illustrates an example of 3D space positions of virtual objects in a mapping of a space about a user wearing a NED device.

FIG. 2B illustrates an example of an image source as a microdisplay displaying front image data and peripheral image data at the same time.

FIG. 3 is a block diagram of an embodiment of a system from a software perspective for indicating an object on a peripheral display of a near-eye display device.

FIG. 4A is a flowchart of an embodiment of a method for indicating an object on a peripheral display of a near-eye display device.

FIG. 4B is a flowchart of a process example for generating a visual representation of at least a portion of an object based on an angular resolution of the peripheral display.

FIG. 5A is a block diagram illustrating an embodiment of a peripheral display using optical elements.

FIG. 5B is a block diagram illustrating an embodiment of a peripheral display using a waveguide display.

FIG. 5C is a block diagram illustrating an embodiment of a peripheral projection display using a wedge optical element.

FIG. 5D is a block diagram illustrating an embodiment of a peripheral projection display using a wedge optical element and its own separate image source.

FIG. 5E is a block diagram illustrating another embodiment of a peripheral display as a projection display.

FIG. 5F is a block diagram illustrating an embodiment of a peripheral display as a direct view image source.

FIG. 5G is a block diagram illustrating an embodiment of a peripheral display as one or more photodiodes.

FIGS. 6A, 6B and 6C illustrate different stages in an overview example of making a Fresnel structure which may be used as part of a peripheral display.

FIG. 7 is a block diagram of one embodiment of a computing system that can be used to implement a network accessible computing system, a companion processing module or control circuitry of a near-eye display device.

### DETAILED DESCRIPTION

An example of a near-eye display (NED) is a head mounted display (HMD). A NED device may be used for displaying image data of virtual objects in a field of view with real objects for an augmented or mixed reality experience. In a virtual reality system, a NED may display computer controlled imagery independent of a real world relationship. In another example, a near-eye display may be used in applications for enhancing sight like an infrared imaging device, e.g. a night vision device. A peripheral field of view provided by a NED device helps imitate the situational awareness provided by natural peripheral vision. Generally, the field of view of NEDs is affected by practical factors like space, weight, power and cost (SWaP-C). A peripheral display for a near-eye display device is also affected by these factors. Some embodiments of peripheral display technology for use with a NED device are described below which are practical by being cost effective for a commercial product and feasible to manufacture commercially.

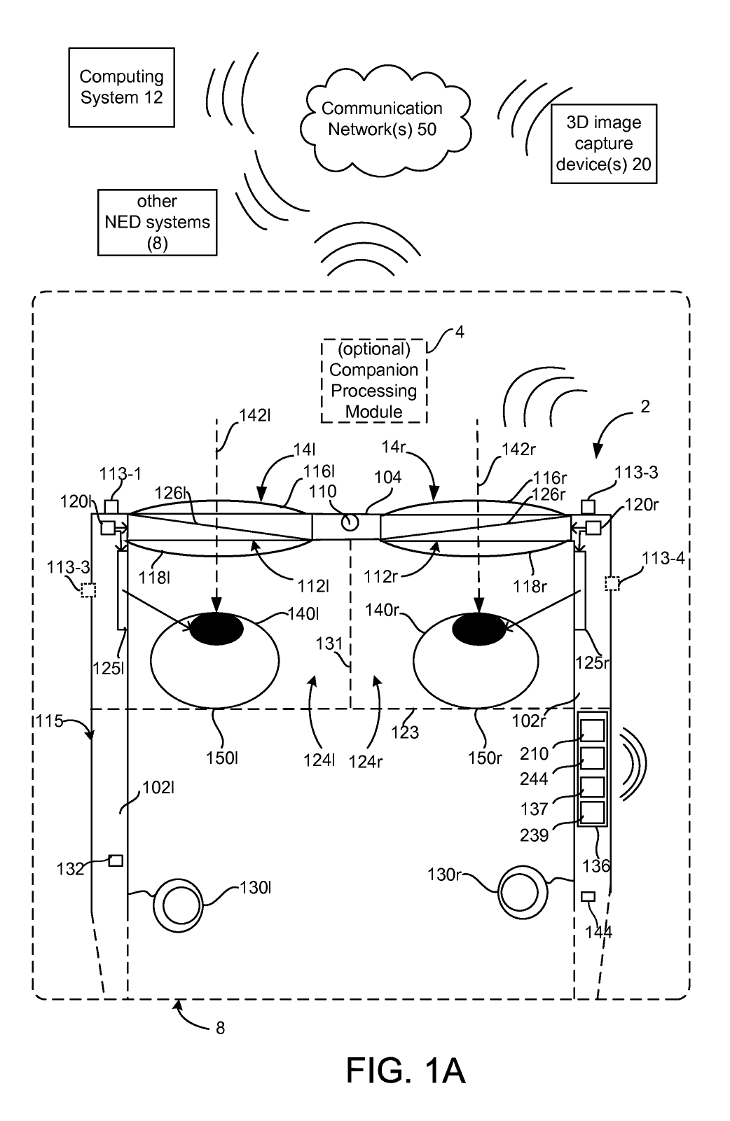

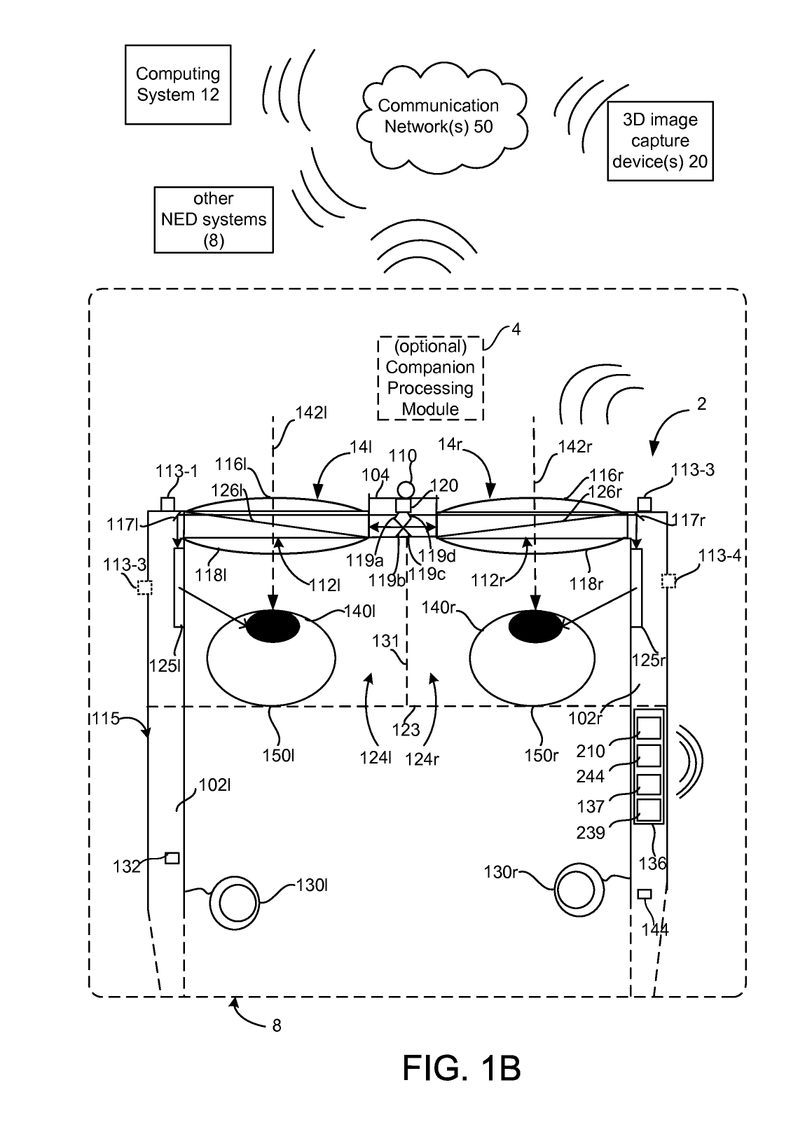

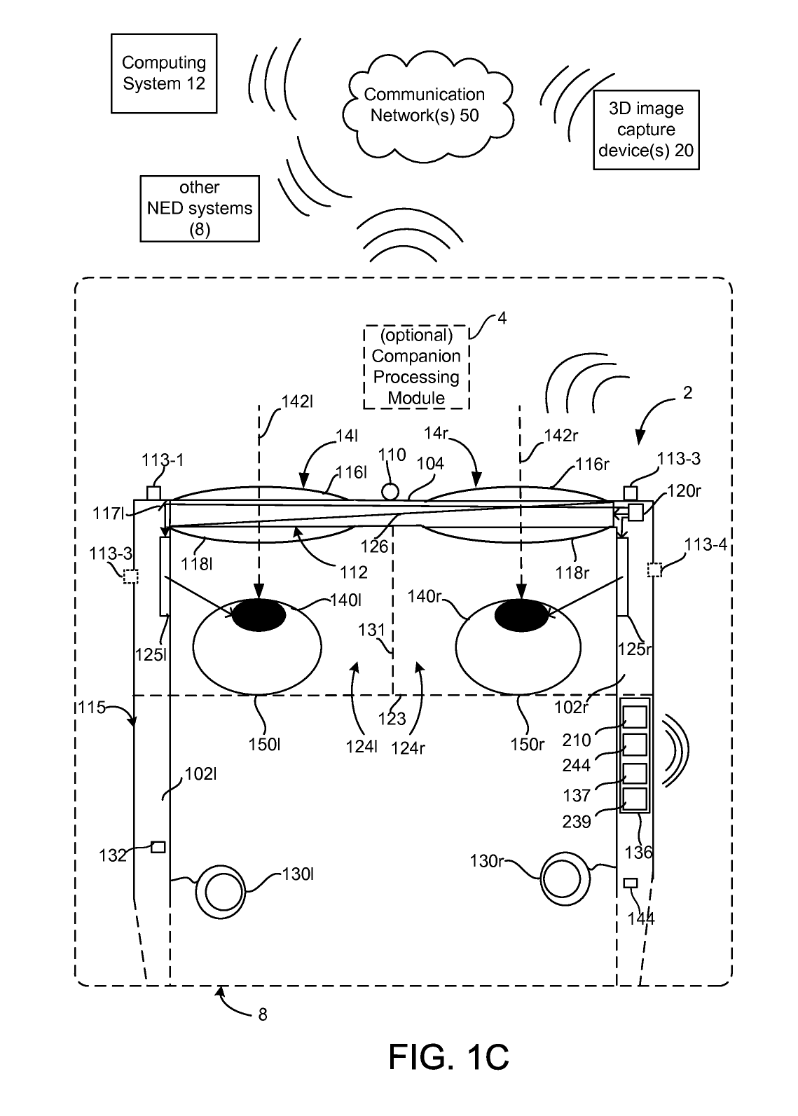

FIG. 1A is a block diagram of an embodiment of a near-eye display device system 8 including a peripheral display 125 in an exemplary system environment. The system includes a near-eye display (NED) device as a head mounted display (HMD) device 2 and, optionally, a communicatively coupled companion processing module 4. In the illustrated embodiment, the NED device 2 and the companion processing module 4 communicate wirelessly with each other. In other examples, the NED display device 2 may have a wired connection to the companion processing module 4. In embodiments without a companion processing module 4, the display device system 8 is the display device 2.

In this embodiment, NED device 2 is in the shape of eyeglasses in a frame 115, with a respective display optical system 14 positioned at the front of the NED device to be seen through by each eye for a front field of view when the NED is worn by a user. In this embodiment, each display optical system 14 uses a projection display in which image data is projected into a user's eye to generate a display of the image data so that the image data appears to the user at a location in a three dimensional field of view in front of the user. For example, a user may be playing a shoot down enemy helicopter game in an optical see-through mode in his living room. An image of a helicopter appears to the user to be flying over a chair in his living room, not between lenses 116 and 118 as a user cannot focus on image data that close to the human eye. The display generating the image is separate from where the image is seen. Each display optical system 14 is also referred to as a front display, and the two display optical systems 14 together may also be referred to as a front display.

At a side of each front display 14 is a respective peripheral display 125. As a near-eye display device is being described, a near-eye support structure like the illustrated eyeglass frame 115 positions each front display in front of an eye area 124 associated with the device 2 for directing image data towards the eye area, and each peripheral display is positioned by the near-eye support structure on a side of the eye area for directing image data towards the eye area from the side. An example of an eye area 124 associated with a near-eye display device is the left area 1241 between side arm 1021 and dashed line 131 and also extending from the front display 14l to dashed line 123. An example right eye area 124r associated with the NED device 2 extends from the right side arm 102r to the central dashed line 131, and from the front display 14r to the dashed line 123. Points 150l and 150r are approximations of a fovea location for each respective eye. Basically, a peripheral display is not going to be put where the frame sits on a user's ear as the user will not see anything displayed by it. In many embodiments, an eye area is simply a predetermined approximation of the location of an eye relative to the front display. For example, the approximation may be based on data gathered over time in the eye glass industry for different frame sizes for different head sizes. In other examples, the eye area may be approximated based on the head size of the NED display device and a model of the human eyeball. An example of such a model is the Gullstrand schematic eye model.

Also in this embodiment, there is a respective image source 120 generating image data for both the front display 14 and a peripheral display 125 on the same side of the display device. For example, on the left side image source 120l provides image data for the left front display 14l and the left peripheral display 125l. Some examples of image sources are discussed further below. In other embodiments, the peripheral display receives its image data from a separate image source. Optical coupling elements are not shown to avoid overcrowding the drawing, but they may be used to couple the respective type of image data from its source to its respective display.

Image data may be moving image data like video as well as still image data. Image data may also be three dimensional (3D). An example of 3D image data is a hologram. Image data may be captured of a real object, and in some examples displayed. Image data may be generated to illustrate virtual objects or a virtual effect. An example of a virtual effect is an atmospheric condition like fog or rain.

In some embodiments, the front display may be displaying image data in a virtual reality (VR) context. For example, the image data is of people and things which move independently from the wearer's real world environment, and light from the user's real world environment is blocked by the display, for example via an opacity filter. In other embodiments, the front display may be used for augmented reality (AR). A user using a near-eye, AR display sees virtual objects displayed with real objects in real time. In particular, a user wearing an optical see-through, augmented reality display device actually sees with his or her natural sight a real object, which is not occluded by image data of a virtual object or virtual effects, in a display field of view of the see-through display, hence the names see-through display and optical see-through display. For other types of augmented reality displays like video-see displays, sometimes referred to as video see-through displays, or a display operating in a video-see mode, the display is not really see-through because the user does not see real objects with his natural sight, but sees displayed image data of unoccluded real objects as they would appear with natural sight as well as image data of virtual objects and virtual effects. References to a see-through display below are referring to an optical see-through display.

Frame 115 provides a support structure for holding elements of the system in place as well as a conduit for electrical connections. In this embodiment, frame 115 provides a convenient eyeglass frame as a near-eye support structure for the elements of the NED device discussed further below. Some other example of a near-eye support structure are a visor frame or a goggles support. The frame 115 includes a nose bridge 104 with a microphone 110 for recording sounds and transmitting audio data to control circuitry 136. A temple or side arm 102 of the frame rests on each of a user's ears, and in this example, the right side arm 102r is illustrated as including control circuitry 136 for the NED device 2.

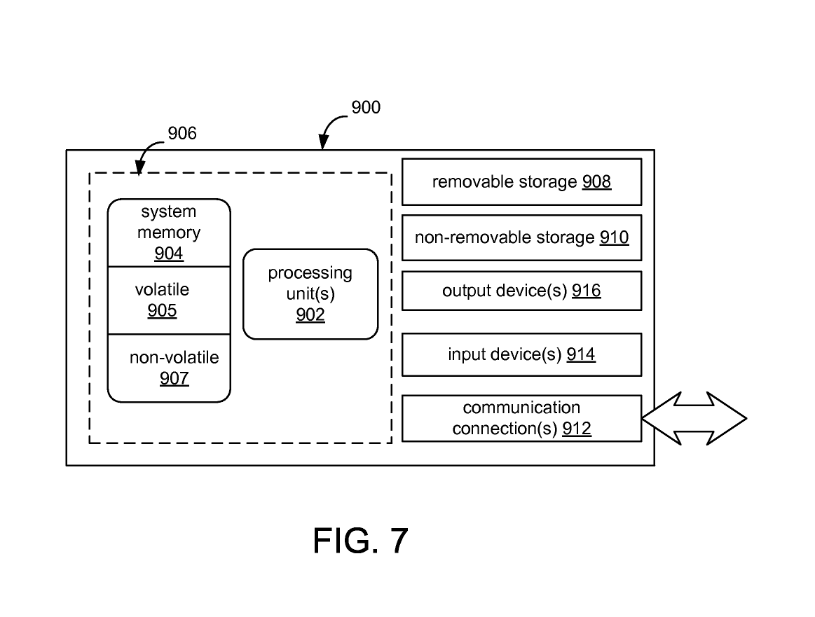

An optional companion processing module 4 may take various embodiments. In some embodiments, companion processing module 4 is a separate unit which may be worn on the user's body, e.g. a wrist, or be a separate device like a mobile device (e.g. smartphone). The companion processing module 4 may communicate wired or wirelessly (e.g., WiFi, Bluetooth, infrared, an infrared personal area network, RFID transmission, wireless Universal Serial Bus (WUSB), cellular, 3G, 4G or other wireless communication means) over one or more communication networks 50 to one or more computer systems 12 whether located nearby or at a remote location, other near-eye display device systems 8 in a location or environment, for example as part of peer-to-peer communication, and if available, one or more 3D image capture devices 20 in the environment. In other embodiments, the functionality of the companion processing module 4 may be integrated in software and hardware components of the display device 2. Some examples of hardware components of the companion processing module 4 are shown in FIG. 7.

One or more network accessible computer system(s) 12 may be leveraged for processing power and remote data access. An example of hardware components of a computer system 12 is shown in FIG. 7. The complexity and number of components may vary considerably for different embodiments of the computer system 12 and the companion processing module 4.

An application may be executing on a computer system 12 which interacts with or performs processing for an application executing on one or more processors in the near-eye display device system 8. For example, a 3D mapping application may be executing on the one or more computers systems 12 and the user's near-eye display device system 8. In some embodiments, the application instances may perform in a master and client role in which a client copy is executing on the near-eye display device system 8 and performs 3D mapping of its display field of view, receives updates of the 3D mapping from the computer system(s) 12 including updates of objects in its view from the master 3D mapping application and sends image data, and depth and object identification data, if available, back to the master copy. Additionally, in some embodiments, 3D mapping application instances executing on different near-eye display device systems 8 in the same environment share data updates in real time, for example real object identifications in a peer-to-peer configuration between systems 8.

The term “display field of view” refers to a field of view of a display of the display device system. The display field of view of the front display is referred to as the front display field of view, and the display field of view of the peripheral display is referred to as the peripheral field of view. In other words, the display field of view approximates a user field of view as seen from a user perspective. The fields of view of the front and peripheral displays may overlap. In some embodiments, the display field of view for each type of display, may be mapped by a view dependent coordinate system, having orthogonal X, Y and Z axes in which a Z-axis represents a depth position from one or more reference points. For example, the front display may use a reference point for each front display 14l, 14r, such as the intersection point of the optical axis 142 for each front display. Each peripheral display 125 may use a center of a display or reflecting element making up a peripheral display as a reference point for an origin for the Z-axis.

In the illustrated embodiment of FIG. 1, the one or more computer systems 12 and the portable near-eye display device system 8 also have network access to one or more 3D image capture devices 20 which may be, for example, one or more cameras that visually monitor one or more users and the surrounding space such that gestures and movements performed by the one or more users, as well as the structure of the surrounding space including surfaces and objects, may be captured, analyzed, and tracked. Image data, and depth data if captured by the one or more 3D image capture devices 20 may supplement data captured by one or more capture devices 113 of one or more near-eye display device systems 8 in a location. The one or more capture devices 20 may be one or more depth cameras positioned in a user environment.

At the front of frame 115 are depicted physical environment facing capture devices 113, e.g. cameras, that can capture image data like video and still images, typically in color, of the real world to map real objects at least in the front display field of view of the front display of the NED device, and hence, in the front field of view of the user. In some embodiments, the capture devices may be sensitive to infrared (IR) light or other types of light outside the visible light spectrum like ultraviolet. Images can be generated based on the captured data for display by applications like a night vision application. The capture devices 113 are also referred to as outward facing capture devices meaning facing outward from the user's head. Optionally, there may be outward facing side capture devices like 113-3 and 113-4 which also capture image data of real objects in the user's environment which can be used for 3D mapping. For example, the side capture devices may be used with a night vision NED device for identifying real objects with infrared sensors on either side of a user which may then be visually represented by a peripheral display.

In some examples, the capture devices 113 may also be depth sensitive, for example, they may be depth sensitive cameras which transmit and detect infrared light from which depth data may be determined. In other examples, a separate depth sensor (not shown) on the front of the frame 115, or its sides if side capture devices 113-3 and 113-4 are in use, may also capture and provide depth data to objects and other surfaces in the display field of view. The depth data and image data form a depth map of the captured field of view of the capture devices 113 which are calibrated to include the one or more display fields of view. A three dimensional (3D) mapping of a display field of view can be generated based on the depth map.

In some embodiments, the outward facing capture devices 113 provide overlapping image data from which depth information for objects in the image data may be determined based on stereopsis. Parallax and contrasting features such as color may also be used to resolve relative positions of real objects.

Control circuitry 136 provides various electronics that support the other components of head mounted display device 2. In this example, the right side arm 102 includes control circuitry 136 for the display device 2 which includes a processing unit 210, a memory 244 accessible to the processing unit 210 for storing processor readable instructions and data, a wireless interface 137 communicatively coupled to the processing unit 210, and a power supply 239 providing power for the components of the control circuitry 136 and the other components of the display device 2 like the capture devices 113, the microphone 110 and the sensor units discussed below. The processing unit 210 may comprise one or more processors including a central processing unit (CPU) and a graphics processing unit (GPU), particularly in embodiments without a separate companion processing module 4, which contains at least one graphics processing unit (GPU).

Inside, or mounted to a side arm 102, are an earphone of a set of earphones 130, an inertial sensing unit 132 including one or more inertial sensors, and a location sensing unit 144 including one or more location or proximity sensors, some examples of which are a GPS transceiver, an infrared (IR) transceiver, or a radio frequency transceiver for processing RFID data. In one embodiment, inertial sensing unit 132 includes a three axis magnetometer, a three axis gyro, and a three axis accelerometer as inertial sensors. The inertial sensors are for sensing position, orientation, and sudden accelerations of head mounted display device 2. From these sensed movements, head position, and thus orientation of the display device, may also be determined which indicate changes in the user perspective and the display field of view for which virtual data is updated to track with the user perspective. In this embodiment, each of the devices processing an analog signal in its operation include control circuitry which interfaces digitally with the digital processing unit 210 and memory 244 and which produces or converts analog signals, or both produces and converts analog signals, for its respective device.

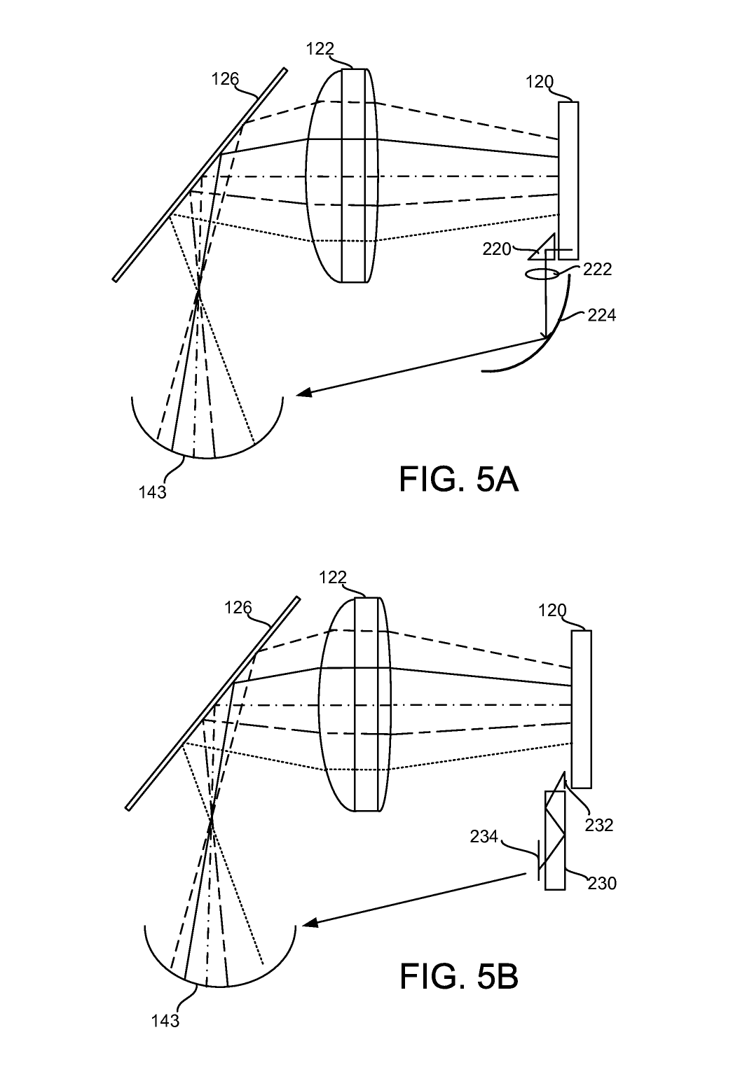

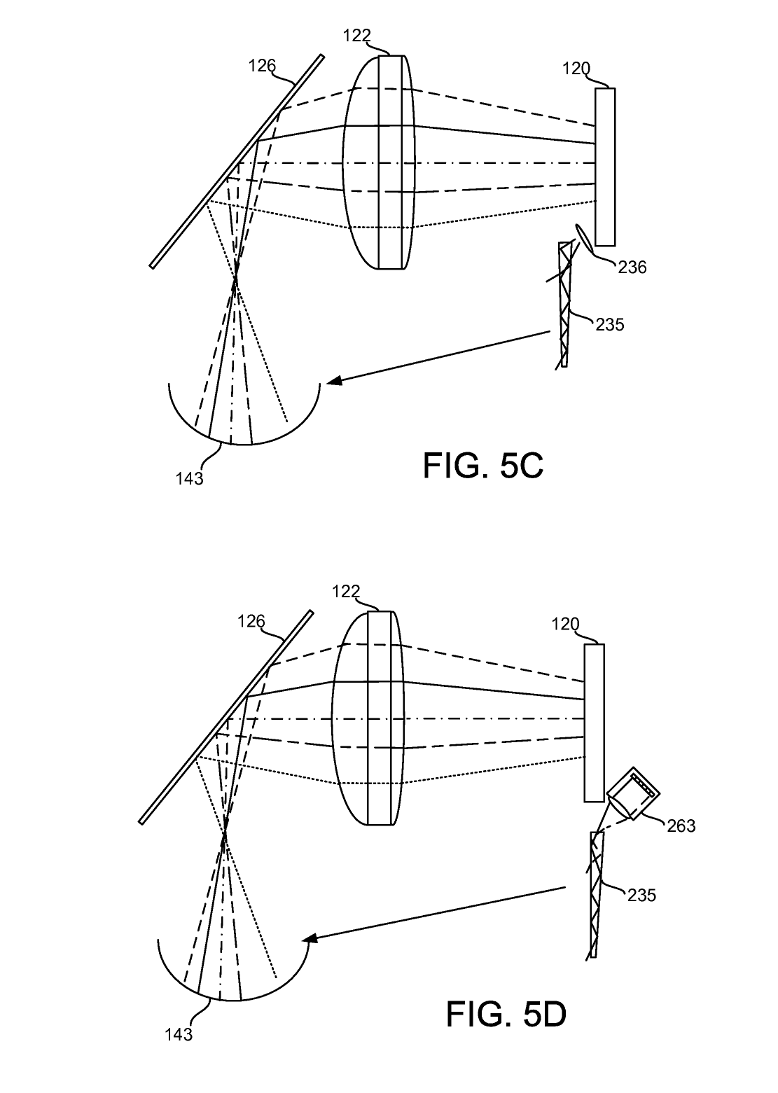

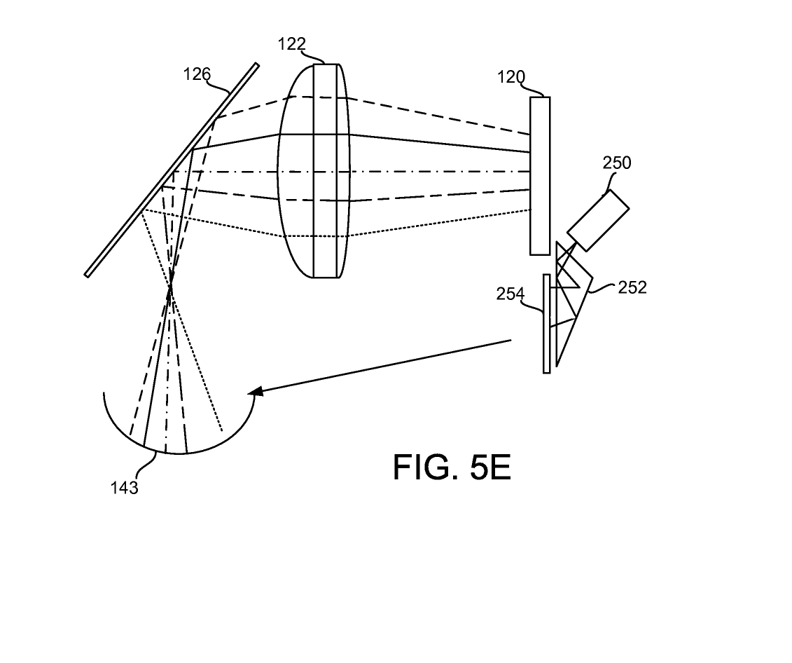

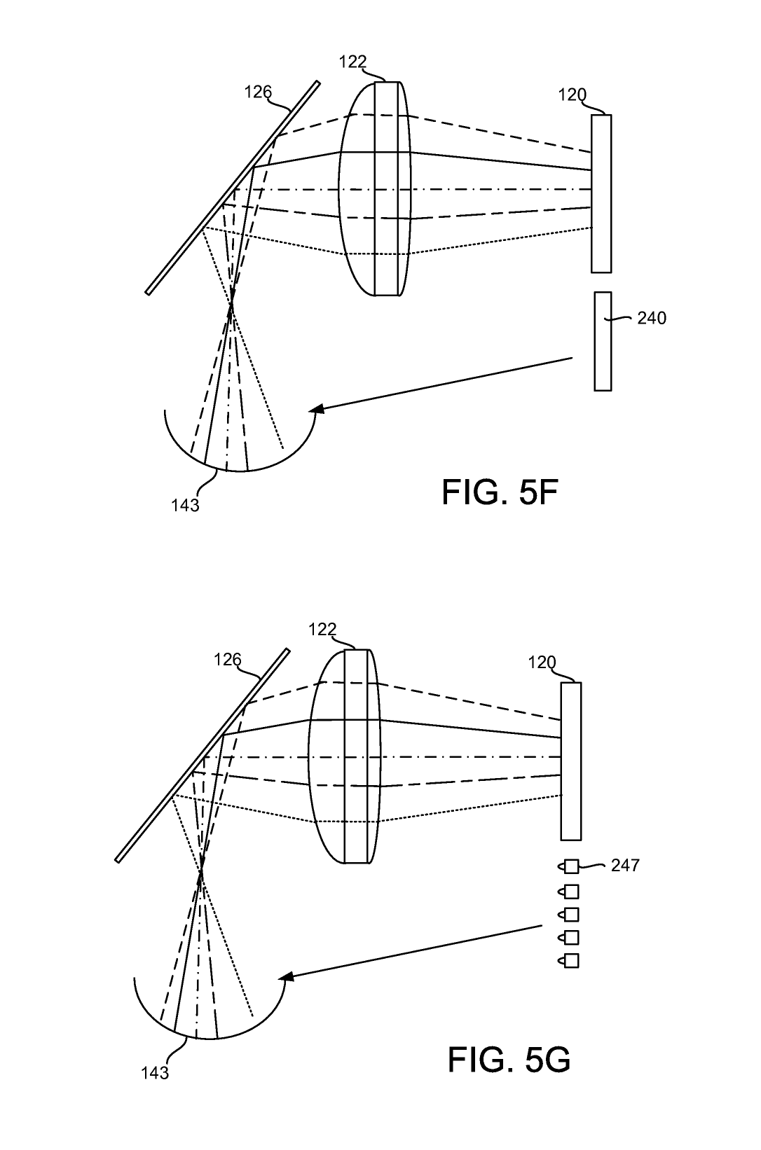

The tracking of the user's head position and the 3D mapping of at least the display fields of view are used for determining what visual representation to represent to a user in the different experiences like augmented reality, virtual reality and night vision by one or more processors of the NED device system 8 or a network accessible computer system 12 or a combination of these. In some embodiments, such as those illustrated below in FIGS. 5A through 5G, a visual representation determined for peripheral display may be received electronically by the peripheral display for the display to represent visually, or the visual representation may be optically transferred as light to the peripheral display which may in some embodiments direct the received light towards the eye area.

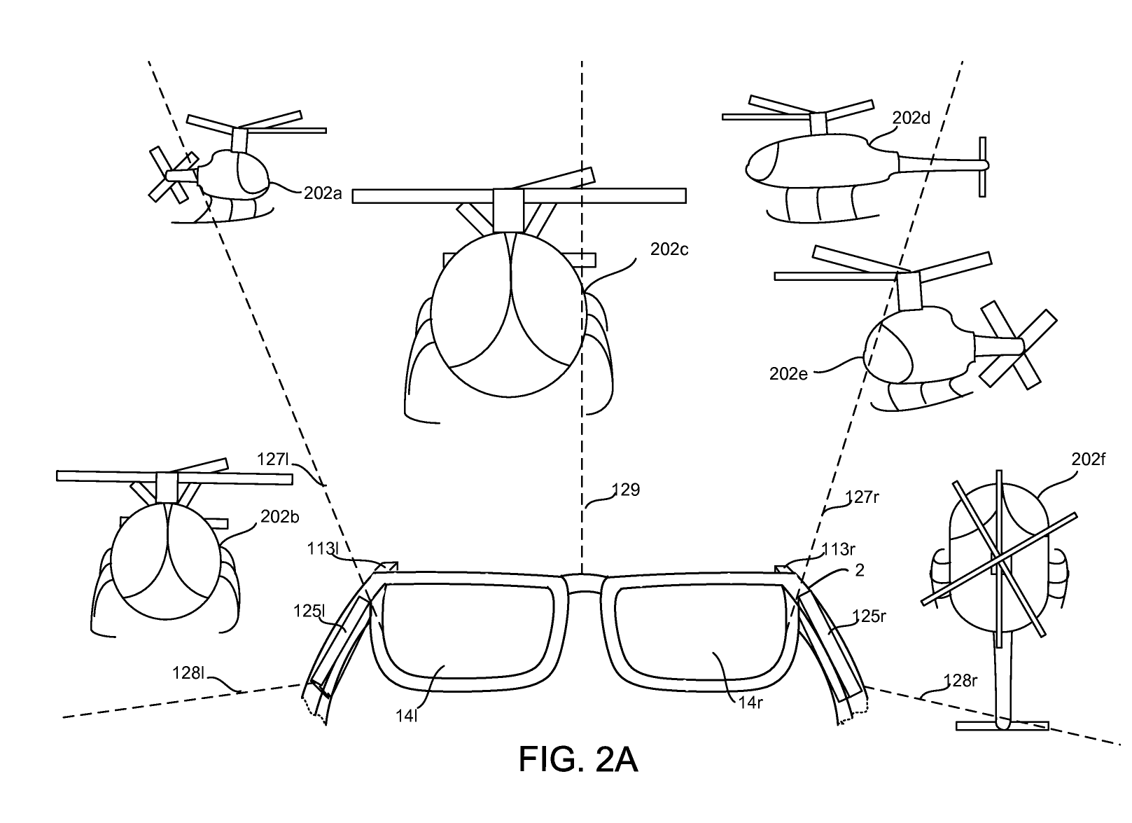

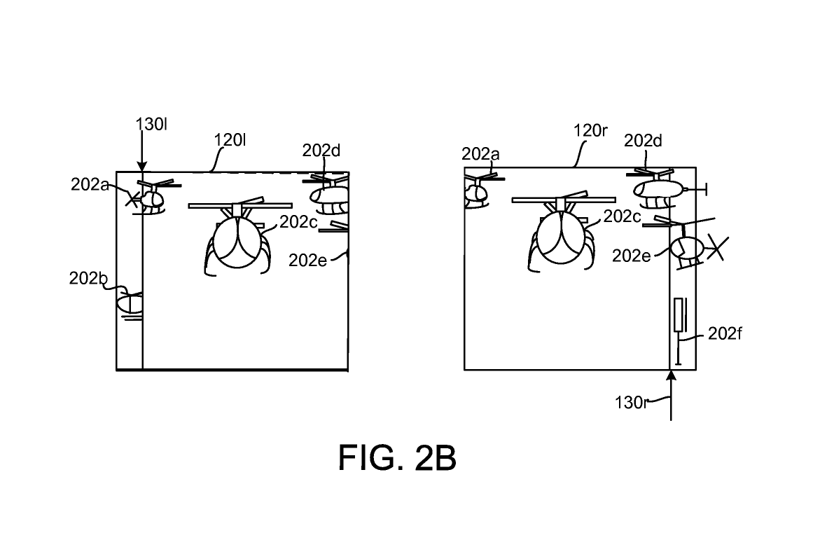

In the embodiment of FIG. 1, image data is optically coupled (not shown) to each front display 14 and to each peripheral display 125 from an image source 120 mounted to or inside each side arm 102. The details of optical coupling are not shown in this block diagram but examples are illustrated below in FIGS. 5A through 5C. FIG. 2A below illustrates an example of a microdisplay as an image source and its display showing image data for the front display and image data on a side of its display for the peripheral display. As illustrated, the image data for the front display is different than the visual representation, image data in this example, for the peripheral display. The front image data and the peripheral image data are independent of each other in that they are for different perspectives, and hence different displays. For example, the microdisplay may be displaying higher resolution image data of a helicopter about 200 meters ahead in a shoot down game while displaying a visual representation of another helicopter 10 meters to the user's left on a set of pixels designated for the left peripheral display 125l.

The image source 120 can display a virtual object to appear at a designated depth location in a display field of view to provide a realistic, in-focus three dimensional display of a virtual object which can interact with one or more real objects. In some examples, rapid display of multiple images or a composite image of the in-focus portions of the images of virtual features may be used for causing the displayed virtual data for either type of display to appear in different focal regions. Again, different depths may be generated by the image source for the peripheral image data than for the front image data simultaneously.

In this embodiment, at least the front displays 14l and 14r are optical see-through displays, and each front display includes a display unit 112 illustrated between two optional see-through lenses 116 and 118 and including a representative reflecting element 126 representing the one or more optical elements like a half mirror, grating, and other optical elements which may be used for directing light from the image source 120 towards the front of the eye area, e.g. the front of the user eye 140. One or more of lenses 116 or 118 may include a user's eyeglass prescription in some examples. Light from the image source is optically coupled into a respective display unit 112 which directs the light representing the image towards a front the eye area, for example to the front of a user's eye 140 when the device 2 is worn by a user. An example of a display unit 112 for an optical see-through NED includes a light guide optical element. An example of a light guide optical element is a planar waveguide.

In an augmented reality embodiment, display unit 112 is see-through as well so that it may allow light from in front of the head mounted, display device 2 to be received by eye 140, as depicted by an arrow representing an optical axis 142 of the each front display, thereby allowing the user to have an actual direct view of the space in front of NED device 2 in addition to seeing an image of a virtual feature from the image source 120. The use of the term “actual direct view” refers to the ability to see real world objects directly with the human eye, rather than seeing created image representations of the objects. For example, looking through glass at a room allows a user to have an actual direct view of the room, while viewing a video of a room on a television is not an actual direct view of the room. An optional opacity filter (not shown) may be included in the display unit 112 to enhance contrast of image data against a real world view in an optical see-through AR mode or to block light from the real world in a video see mode or a virtual reality mode.

In some embodiments, each display unit 112 may also optionally include an integrated eye tracking system. For example, an infrared (IR) illumination source may be optically coupled into each display unit 112. The one or more optical elements which direct light towards the eye area may also direct the IR illumination towards the eye area and be bidirectional in the sense of being able to direct IR illumination from the eye area to an IR sensor such as an IR camera. A pupil position may be identified for each eye from the respective IR data captured, and based on a model of the eye and the pupil position, a gaze line for each eye may be determined by software, and a point of gaze typically in the front display field of view can be identified. An object at the point of gaze may be identified as an object of focus.

FIG. 1B is a block diagram of another embodiment of a near-eye display device including a peripheral display in an exemplary system environment. In this embodiment, a single image source 120 in the nose bridge 104 provides the front image data and the peripheral image data for both the front displays 14 and both peripheral displays 125l and 125r. In this example, a respective subset of the display area displays peripheral image data to be optically directed to its corresponding peripheral display. Representative elements 119a and 119b represent one or more optical elements for directing the respective peripheral image data into the display unit 112, here a light guide optical element (e.g. a waveguide), at an angle so the peripheral image data travels the display unit 12 without being directed to the user's eye, and exits the display unit for optical coupling into the respective peripheral display 125. Elements 117l and 117r are representative of one or more optical elements for directing the light to its respective peripheral display.

FIG. 1C is a block diagram of yet another embodiment of a near-eye display device including a peripheral display in an exemplary system environment. In this embodiment, the display unit 112 including representative element 126 extends through the nose bridge 104 for both eyes to look through, and a side image source 120 provides image data for the front display 14 and the peripheral displays. In the example, the right side arm 102r includes the image source 120r, but the image source can also be on the other side in different examples. Optical coupling elements are not shown to avoid overcrowding the drawing, but they may be used to couple the respective type of image data from its source to its respective display. The image source 120r displays on different portions of its display area peripheral image data for the left and right peripheral displays and the front display. In this example, peripheral image data for the left peripheral display is directed into the front display unit 112 at such an angle as to travel the front display without being directed to the user eye and exiting to one or more optical coupling elements represented by element 117l which directs the left peripheral image data to the left peripheral display. The front image data and the right peripheral image data are directed to their respective displays as in the embodiment of FIG. 1A.

Before discussing the illustrative example of FIG. 2A, a short overview about rods and cones on a human retina follows. A human eye “sees” by reflections of light in a certain wavelength band being received on the human retina. At the center of the retina is the fovea. Objects which reflect light which reaches the fovea are seen with the highest sharpness or clarity of detail for human sight. This type of clear vision is referred to as foveal vision. In the typical case of using both eyes, a point of gaze or an object of focus for human eyes is one for which light is reflected back to both of a human's fovea. An example of an object of focus is a word on a book page.

The fovea has the highest density of cones or cone photoreceptors. Cones allow humans to perceive a wider range of colors than other living things. Cones are described as red cones, green cones and blue cones based on their sensitivities to light in these respective spectrum ranges. Although cones have a smaller bandwidth of light to which they are sensitive than rods discussed below, they detect changes in light levels more rapidly than rods. This allows more accurate perception of detail including depth and changes in detail than rods provide. In other words, cones provide a higher resolution image to our brains than our rods do. From the fovea at the center of the retina, the amount of cones reduces, and the number of rods increases resulting in human perception of detail falling off with angular distance from the center of the field of view for each eye.

The rods vastly outnumber the cones on the retina, and they capture light from a wider field of view as they predominate on most of the retina. Thus, they are associated with human peripheral vision. Rods are significantly more sensitive to light than cones, however their sensitivity is significantly less in the visible light or color range than for cones. Rods are much more sensitive to shorter wavelengths towards the green and blue end of the spectrum. Visual acuity or resolution is better for cones, but a human is better able to see an object in dim light with peripheral vision than with cones in foveal vision due to the sensitivity of rods. Cones are much more adapted at detecting and representing changes of light than rods, so the perception of detail when first entering a dark place is not as good as after being in the dark place about a half or so later. The rods take longer to adjust to light changes, but can provide better vision of objects in dim light.

Although, rods provide the brain with images that are not as well defined and color nuanced, they are very sensitive to motion. That sense of someone is coming up to my right side or something moved in the darkness is the result of rod sensitivity. The farther an object is from the center of a field of view of human vision, the more out of focus and less detailed it may appear, but if still within the periphery of the field of view, its presence is detected by the rods.

A successful virtual reality or augmented reality experience is seeing image data of virtual objects as if they were real objects seen with natural sight, and real objects don't completely disappear right at the edge of the field of view for foveal vision in natural sight. Having displays with resolutions suitable for our foveal vision both in front and on the sides or periphery of a display device is not warranted either based on the limitations of human peripheral vision.

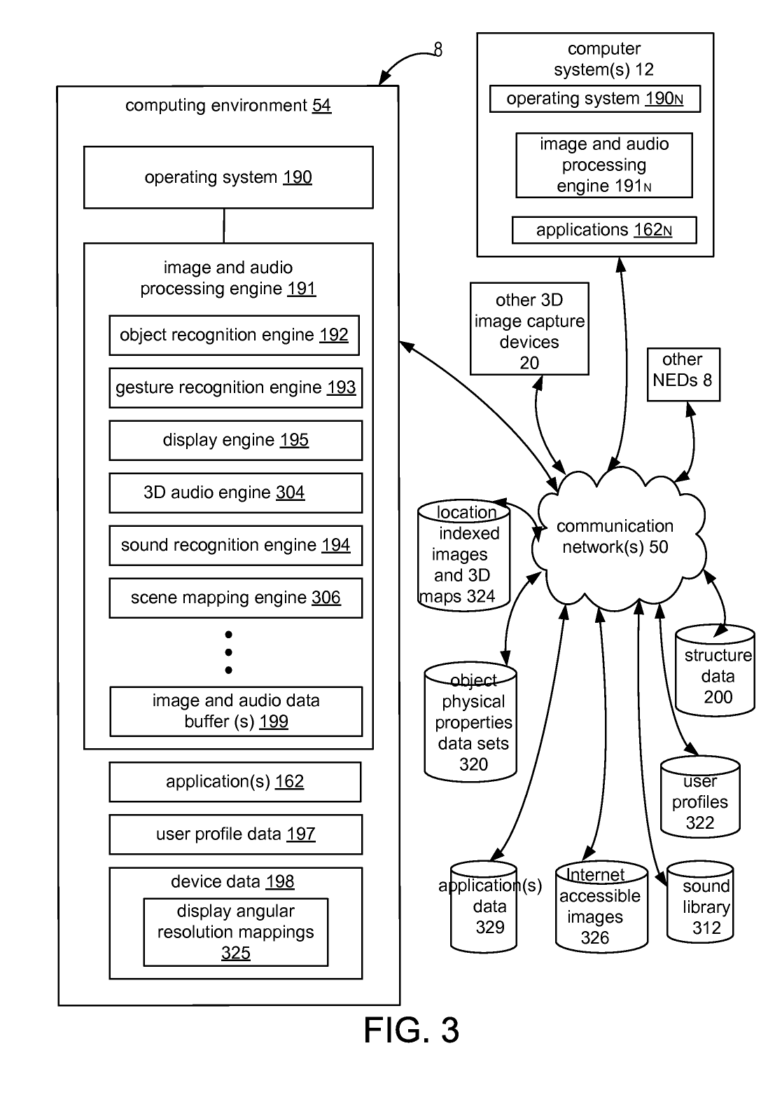

FIG. 2A illustrates an example of 3D space positions of virtual objects in a mapping of a space about a user wearing a display device 2. A 3D space position identifies how much space an object occupies and where in a 3D display field of view that occupied space is positioned. The exemplary context is a game in which a user shoots at enemy helicopters 202. (Mapping of real and virtual objects is discussed in more detail with reference to FIG. 3.)

In FIG. 2A, the area between lines 127l and 127r represents the field of view of the front display 14, for example a display including both display optical systems 14l and 14r in the embodiment of FIG. 1. The field of view of the front display is hereafter referred to as the front display field of view. Dashed line 129 approximates a center of the front display field of view and the combined front and peripheral displays fields of view. The area between lines 128l and 127l is an exemplary field of view of peripheral display 125l on the left side of the display device 2, and the area between lines 128r and 127r is an exemplary field of view of peripheral display 125r on the right side of the display device 2 in this embodiment. A field of view of a peripheral display is here referred to as a peripheral display field of view. The combination of the peripheral fields of view and the front display field of view make up the display device field of view in this example. Again these are just examples of the extents of fields of view for the displays. In other examples of NEDs, the front field of view may be narrower and there may be gaps between the front display field of view and the peripheral display field of view. In other examples, the display fields of view may overlap.

The helicopters in FIG. 2A are illustrated at a resolution which would be used by a front display. Due to the limits of human peripheral vision, a user would not see all the illustrated helicopters at such a front display resolution. FIG. 2A in use with FIG. 2B illustrates the lower resolution which a peripheral display can take advantage of due to the differences between human foveal or front vision and human peripheral vision. In other words, while virtual helicopter 202c will be displayed entirely at a resolution for the front display, helicopters 202b and 202f and the portions of helicopters 202a, 202d and 202e in the peripheral fields of view will be displayed at a display resolution of the appropriate peripheral display which is lower than that of the front display.

Helicopter 202b is flying on a course heading straight past the left side of the user's head, and helicopter 202f is flying with its nose pointing straight up in the right peripheral display field of view. Helicopter 202a is heading into the front display field of view and has its tail and tail rotors in the upper left peripheral display field of view while its body is in the front display field of view. Helicopter 202d is on a level trajectory heading straight across the front display field of view and part of its tail and its tail rotors are still in the peripheral field of view. Helicopter 202e is on a slightly downward trajectory coming from the right peripheral display field of view towards the lower left of the front display field of view. Some of its top rotors and the nose of helicopter 202e are in the front field of view while the rest of the helicopter is in the right peripheral field of view at this image frame representing a snapshot of the motion at a particular time. These virtual helicopters 202 are in motion, and the user is highly likely moving his head to take shots at the helicopters, so the image data is being updated in real time.

FIG. 2B illustrates some examples of an image source as a microdisplay displaying front image data for the front display and peripheral image data for the peripheral display at the same time. The view illustrated is from a user perspective facing the microdisplay straight on. Illustrated is an image source 120l displaying front image data in its display area to the right of arrow 130l and peripheral image data for a left side peripheral display in the display area to the left of arrow 130l. In the example embodiment of FIG. 1, the left front display 14 receives and directs the image data to the right of 130l towards the front of the eye area where it will reflect off a user's left eye retina and appear projected into 3D space in front of the user.

In the peripheral image data displayed in the display area to the left of arrow 130l, the tail rotors of helicopter 202a are lines rather than rectangular shapes with area, and the tail is more like a small rectangle than a curving shape as in FIG. 2A. The image resolution of the portion of helicopter 202a in the peripheral field of view is commensurate with the angular resolution of the left peripheral display 125l which is lower than that of the front display 14l so more image data is mapped to a smaller display area than for the front display thereby decreasing the detail visible in the image. As discussed further below, each display's angular resolution is predetermined and maps positions within angular ranges in a field of view to display locations, for example, pixels. The higher the display resolution, the smaller an angular range in the field of view which is mapped to each display location.

Peripheral image data visually representing helicopter 202b to the left of arrow 130l shows a less detailed version of the helicopter from the side with top rotors thinned to lines, curved landing supports straightened, cockpit window outline a line rather than a curve and the body of helicopter 202b more elliptical. The less detailed side view is displayed and directed to the left peripheral display as an out of focus side view is what a user would see as helicopter 202b is passing the left side of the user's head if it were real. For this frame, the front portion of helicopter 202b is displayed, and the thinned tail and rotors are to be displayed in the next frame for update on the peripheral left display 125l. The frames are updated faster than a rate a human eye can detect.

The peripheral image data for the right peripheral display 125r is displayed on the display area of the microdisplay 120r to the right of the arrow 130r. The tail end of the body of helicopter 202d has been streamlined due to the difference in angular resolution between the front and peripheral display 125r. The thinned tail and tail rotors for helicopter 202d extending beyond the edge of the microdisplay is just for illustrating image data in an image buffer which will be displayed in the next frame. Similarly, for helicopter 202e on a trajectory entering the front display field of view, the front portion of the rotors are displayed at a resolution for the front display to the left of arrow 130r which shows them with rectangular area. The body of the helicopter 202e has more of an elliptical streamlined shape and the cockpit outline is more linear than curved commensurate with the loss of detail for a lower resolution display. Less detailed peripheral image data of the back half of the cockpit, thinned tail and tail rotors and the back half of straight lines representing the landing gear are ready for display in subsequent frames in this example.

Helicopter 202f shows significantly more loss of detail with a rectangular body for the cockpit of helicopter 202f and lines representing the rotor and tail. However, helicopter 202f is over ninety (90) degrees from the center of the field of view 129 in this example, so natural human vision would not be seeing great detail of helicopter 202f, but would provide the sensation of its motion and direction of motion which display of the less detailed version of virtual helicopter 202f on the right peripheral display 125r also presents. Additionally, the peripheral image data is a side view of helicopter 202f as it is virtually ascending with nose straight-up on the user's right head side in accordance with an executing game application.

In other embodiments instead of sharing display space, the image source 120 may alternate between display of peripheral image data and display of front image data on the display area of the microdisplay 120 with a switching mechanism for optically coupling the image data to the appropriate display. For example, for ten frames or display updates of front display data, there is one frame of peripheral image data displayed on the display area used by the front image data in other frames.

In the embodiment of FIG. 2B, depth of objects in the peripheral field of view may be represented by the size of the objects displayed and layering of image data based on 3D mapping positions including a depth position. In other examples whether using a shared image source or separate image sources for the front and peripheral displays, rapid display of multiple images or a composite image including portions of individual images of each virtual feature at a respective predetermined depth are techniques which may be used to make displayed peripheral image data appear in different focal regions if desired. In any event, a peripheral display can take advantage of human behavior in that when a human “sees something out of the corner of his eye,” he naturally moves his head to get a better view of the “something” and avoid discomfort. Thus a visual representation on a peripheral display may cause a user to naturally turn her head so the virtual object is projected to display at its determined 3D space position by the front display.

Display resolution is often described in terms of angular resolution of a near-eye display (NED). In many embodiments, the angular resolution is a mapping of angular portions of a display field of view, which approximates or is within the user's field of view, to locations or areas on the display (e.g. 112, 125). The angular resolution, and hence the display resolution, increases proportionately with a density of separately controllable areas of the display. An example of a separately controllable area of a display is a pixel. For two displays of the same display size, a first one with a greater number of pixels has a higher angular resolution than the second one with a lower number of pixels which will be larger than the pixels of the first display. This is because a smaller portion of the field of view gets more separately controllable pixels to represent its detail in the first display. In other words, the higher the pixel density, the greater the detail, and the higher the resolution.

For a 3D display field of view, e.g. corresponding to at least a portion of a user's natural sight field of view, a depth component may also be mapped to separately controllable display areas or locations. For example, an angular portion near the center of the front display field of view at a first depth distance is mapped to a larger set of separately controllable display areas near the center of each front display 14l, 14r than the same angular portion at a further second depth distance.

The term “pixel” is commonly considered short for “picture element” and generally refers to an area of a display having predetermined size dimensions for a particular type of display which is a unit to which a processor readable address is assigned for control by a processor. The term is used for describing resolution across display technologies ranging from older display technologies like a cathode ray tube (CRT) screen monitor and modern near-eye display technologies like digital light processing (DLP), liquid crystal on silicon (LcOS), organic light emitting diode (OLED), inorganic LED (iLED) and scanning mirrors using (microelectromechanical) MEMs technology. Depending on the technology of the display, the pixel size can be varied for the same display for different uses. Additionally, angular resolution can be varied at the same time between different portions of a same peripheral display. One way to vary the angular resolution is to use different pixel sizes for mapping image data to different portions of a peripheral display.

Using different resolutions takes advantage of the fall-off in natural sight resolution. For example, small fields of view from the center of the eye (see optical axis 142 in FIG. 1) have to have one (1) pixel per arc radian in order for the user to be able to read text clearly. However, a further 50 degrees from the center of the eye, half the number of pixels are used to light up each cone, for example 1 pixel per 2 arc radians so there can be a fifty percent (50%) reduction in pixel count. A further 60 degrees from the center of the eye forty percent (40%) less pixels may be used as the number of cones reduces further and the field of view is within the peripheral display field of view. Again, a further 80 degrees may use seventeen (17%) less pixels to light each cone. At the furthest field of view angles, a visual representation can be effectively a blur represented with a very low pixel count to achieve a surround vision system. Thus in some embodiments, a pixel count on a peripheral display may be decreased at increasing radius amounts from the fovea of the eye which location in some examples may be approximated by the approximated fovea location e.g. 150l, 150r, of the eye area in FIGS. 1A, 1B and 1C for each eye. In other embodiments, for decreasing angular resolution without decreasing pixel size, more pixels may be controlled by the same signal. For example, past fifty (50) degrees from the approximated fovea location of the eye area, two pixels are controlled by the same signal and past 60 degrees, three pixels are controlled with the same signal. What image data is to be represented where on either the front or peripheral displays is determined in accordance with one or more applications executing on computer hardware of the NED device system 8, and in some cases also on a network accessible computer system 12, supported by software which provide services across applications.

FIG. 3 is a block diagram of an embodiment of a system from a software perspective for indicating an object on a peripheral display of a near-eye display device. FIG. 3 illustrates an embodiment of a computing environment 54 from a software perspective which may be implemented by a system like NED system 8, one or more remote computer systems 12 in communication with one or more NED systems or a combination of these. Additionally, a NED system can communicate with other NED systems for sharing data and processing resources, and may communicate with other image capture devices like other 3D image capture devices 20 in an environment for data as well. Network connectivity allows leveraging of available computing resources.

In this embodiment, an application 162 may be executing on one or more processors of the NED system 8 and communicating with an operating system 190 and an image and audio processing engine 191. The application may be for an augmented reality experience, a virtual reality experience, or an enhanced vision experience. Some examples of such applications are games, instructional programs, educational applications, night vision applications and navigation applications. In the illustrated embodiment, a remote computer system 12 may also be executing a version 162N of the application as well as other NED systems 8 with which it is in communication for enhancing the experience.

Application data 329 for one or more applications may also be stored in one or more network accessible locations. Some examples of application data 329 may be rule datastores, reference data for one or more gestures associated with the application which may be registered with a gesture recognition engine 193, execution criteria for the one or more gestures, physics models for virtual objects associated with the application which may be registered with an optional physics engine (not shown) of the image and audio processing engine, and object properties like color, shape, facial features, clothing, etc. of the virtual objects which may be linked with object physical properties data sets 320.

As shown in the embodiment of FIG. 3, the software components of a computing environment 54 comprise the image and audio processing engine 191 in communication with an operating system 190. Image and audio processing engine 191 processes image data (e.g. moving data like video or still), and audio data in order to support applications executing for a head mounted display (HMD) device system like a NED system 8. An embodiment of an image and audio processing engine 191 may include various functionality. The illustrated embodiment shows a selection of executable software elements which may be included, and as indicated by the . . . , other functionality may be added. Some examples of other functionality are occlusion processing, a physics engine or eye tracking software. The illustrated embodiment of an image and audio processing engine 191 includes an object recognition engine 192, gesture recognition engine 193, display data engine 195, a 3D audio engine 304, a sound recognition engine 194, and a scene mapping engine 306.

The computing environment 54 also stores data in image and audio data buffer(s) 199. The buffers provide memory for receiving image data captured from the outward facing capture devices 113 of the NED system 8, image data captured by other capture devices (e.g. 3D image capture devices 20 and other NED systems 8 in the environment) if available, image data from an eye tracking camera of an eye tracking system if used, buffers for holding image data of virtual objects to be displayed by the image generation units 120, and buffers for both input and output audio data like sounds captured from the user via microphone 110 and sound effects for an application from the 3D audio engine 304 to be output to the user via audio output devices like earphones 130. Image and audio processing engine 191 processes image data, depth data and audio data received from one or more capture devices or which may be accessed from location and image data stores like location indexed images and maps 324.

The individual engines and data stores depicted in FIG. 3 are described in more detail below, but first an overview of the data and functions they provide as a supporting platform is described from the perspective of an application 162 which leverages the various engines of the image and audio processing engine 191 for implementing its one or more functions by sending requests identifying data for processing and receiving notification of data updates. For example, notifications from the scene mapping engine 306 identify the positions of virtual and real objects at least in the display field of view. The application 162 identifies data to the display data engine 195 for generating the structure and physical properties of an object for display.

The operating system 190 makes available to applications which gestures the gesture recognition engine 193 has identified, which words or sounds the sound recognition engine 194 has identified, and the positions of objects from the scene mapping engine 306 as described above. A sound to be played for the user in accordance with the application 162 can be uploaded to a sound library 312 and identified to the 3D audio engine 304 with data identifying from which direction or position to make the sound seem to come from. The device data 198 makes available to the application 162 location data, head position data, data identifying an orientation with respect to the ground and other data from sensing units of the display device 2. The device data 198 may also store the display angular resolution mappings 325 mapping angular portions of the field of view to specific display locations like pixels.

The scene mapping engine 306 is first described. In enhanced vision applications like night vision, a 3D mapping of at least a display field of view identifies where to insert image data tracking to real objects in the environment. In augmented reality applications, the 3D mapping is used to identify where to insert virtual objects with respect to real objects. In virtual reality applications, the 3D mapping of real objects may be done for safety as well as determining a user's movement in the virtual reality world even if not a 1 to 1 correspondence. The description below uses an example of an augmented reality experience.

A 3D mapping of the display field of view of each display of a NED device can be determined by the scene mapping engine 306 based on captured image data and depth data. The depth data may either be derived from the captured image data or captured separately. The 3D mapping includes 3D positions for objects, whether real or virtual, in the display field of view. In some embodiments, particularly for a front display, the 3D mapping may include 3D space positions or position volumes for objects as examples of 3D positions. A 3D space is a volume of space occupied by the object. A 3D space position represents position coordinates for the boundary of the volume or 3D space in a coordinate system including the display field of view. In other words the 3D space position identifies how much space an object occupies and where in the display field of view that occupied space is. As discussed further below, in some examples the 3D space position includes additional information such as the object's orientation.

Depending on the precision desired, the 3D space can match the 3D shape of the object or be a less precise bounding shape. The bounding shape may be 3D and be a bounding volume. Some examples of a bounding volume around an object are a bounding box, a bounding 3D elliptical shaped volume, a bounding sphere or a bounding cylinder.

For mapping a peripheral display field of view, 3D positions mapped may not include volume data for an object. For example, 3D coordinates of a center or centroid point of an object may be used to represent the 3D position of the object. In other examples, the 3D position of an object may represent position data in the 3D coordinate system for a 2D shape representing the object. In some embodiments, particularly in a peripheral display example, a 2D bounding shape for example, a bounding circle, rectangle, triangle, etc. and the 3D position of the object are used for rendering a visual representation of the object on the peripheral display with respect to other objects but without representing 3D details of the object's volume.

A depth map representing captured image data and depth data from outward facing capture devices 113 can be used as a 3D mapping of a display field of view of a near-eye display. As discussed above, a view dependent coordinate system may be used for the mapping of the display field of view approximating a user perspective. The captured data may be time tracked based on capture time for tracking motion of real objects. Virtual objects or image data of objects for enhanced vision can be inserted into the depth map under control of an application 162. A bounding shape in two dimensions (e.g. X, Y) or in three dimensions as a volume, may also be associated with a virtual object and an enhanced vision object in the map of a field of view. In some examples, for mapping the field of view of the peripheral displays like 125l and 125r in FIGS. 1A, 1B and 1C, image data from the optional side cameras or capture devices 113-3 and 113-4 may be used in the same way to make a 3D depth map of the peripheral displays fields of view. In other embodiments, the peripheral display fields of view may be mapped based on a 3D mapping of a user's environment.

Mapping what is around the user in the user's environment can be aided with sensor data. Data from an orientation sensing unit 132, e.g. a three axis accelerometer and a three axis magnetometer, determines position changes of the user's head and correlation of those head position changes with changes in the image and depth data from the outward facing capture devices 113 can identify positions of objects relative to one another and at what subset of an environment or location a user is looking.

Depth map data of another HMD device, currently or previously in the environment, along with position and head orientation data for this other HMD device can also be used to map what is in the user environment. Shared real objects in their depth maps can be used for image alignment and other techniques for image mapping. With the position and orientation data as well, what objects are coming into view can be predicted as well so other processing such as buffering of image data can start before the objects are in view.

The scene mapping engine 306 can also use a view independent coordinate system for 3D mapping, and a copy of a scene mapping engine 306 may be in communication with other scene mapping engines 306 executing in other systems (e.g. 12, 20 and 8) so the mapping processing can be shared or controlled centrally by one computer system which shares the updated map with the other systems. Image and depth data from multiple perspectives can be received in real time from other 3D image capture devices 20 under control of one or more network accessible computer systems 12 or from one or more NED systems 8 in the location. Overlapping subject matter in the depth images taken from multiple perspectives may be correlated based on a view independent coordinate system and time, and the image content combined for creating the volumetric or 3D mapping of a location or environment (e.g. an x, y, z representation of a room, a store space, or a geofenced area). Thus, changes in light, shadow and object positions can be tracked. The map can be stored in the view independent coordinate system in a storage location (e.g. 324) accessible as well by other NED systems 8, other computer systems 12 or both, be retrieved from memory and be updated over time. (For more information on collaborative scene mapping between HMDs like apparatus 8 and computer systems 12 with access to image data, see “Low-Latency Fusing of Virtual and Real Content,” having U.S. patent application Ser. No. 12/912,937 having inventors Avi Bar-Zeev et al. and filed Oct. 27, 2010 and which is hereby incorporated by reference.)

When a user enters a location or an environment within a location, the scene mapping engine 306 may query another NED system 8 or a networked computer system 12 for accessing a network accessible location like location indexed images and 3D maps 324 for a pre-generated 3D map or one currently being updated in real-time which map identifies 3D space positions and identification data of real and virtual objects. The map may include identification data for stationary objects, objects moving in real time, objects which tend to enter the location, physical models for objects, and current light and shadow conditions as some examples.

The location may be identified by location data which may be used as an index to search in location indexed image and 3D maps 324 or in Internet accessible images 326 for a map or image related data which may be used to generate a map. For example, location data such as GPS data from a GPS transceiver of the location sensing unit 144 on the near-eye display (NED) device 2 may identify the location of the user. In another example, a relative position of one or more objects in image data from the outward facing capture devices 113 of the user's NED system 8 can be determined with respect to one or more GPS tracked objects in the location from which other relative positions of real and virtual objects can be identified. Additionally, an IP address of a WiFi hotspot or cellular station to which the NED system 8 has a connection can identify a location. Additionally, identifier tokens may be exchanged between NED systems 8 via infra-red, Bluetooth or WUSB. The range of the infra-red, WUSB or Bluetooth signal can act as a predefined distance for determining proximity of another user. Maps and map updates, or at least object identification data may be exchanged between NED systems via infra-red, Bluetooth or WUSB as the range of the signal allows.

The scene mapping engine 306 tracks the position, orientation and movement of real and virtual objects in the volumetric space based on communications with the object recognition engine 192 of the image and audio processing engine 191 and one or more executing applications 162 causing image data to be displayed.

The object recognition engine 192 of the image and audio processing engine 191 detects and identifies real objects, their orientation, and their position in a display field of view based on captured image data and captured depth data if available or determined depth positions from stereopsis. The object recognition engine 192 distinguishes real objects from each other by marking object boundaries and comparing the object boundaries with structural data. One example of marking object boundaries is detecting edges within detected or derived depth data and image data and connecting the edges. A polygon mesh may also be used to represent the object's boundary. The object boundary data is then compared with stored structure data 200 in order to identify a type of object within a probability criteria. Besides identifying the type of object, an orientation of an identified object may be detected based on the comparison with stored structure data 200.

Structure data 200 accessible over one or more communication networks 50 may store structural information such as structural patterns for comparison and image data as references for pattern recognition. Besides inanimate objects, as in other image processing applications, a person can be a type of object, so an example of structure data is a stored skeletal model of a human which may be referenced to help recognize body parts. The image data may also be used for facial recognition. The object recognition engine 192 may also perform facial and pattern recognition on image data of the objects based on stored image data from other sources as well like user profile data 197 of the user, other users profile data 322 which are permission and network accessible, location indexed images and 3D maps 324 and Internet accessible images 326. Motion capture data from image and depth data may also identify motion characteristics of an object. The object recognition engine 192 may also check detected properties of an object like its size, shape, material(s) and motion characteristics against reference properties stored in structure data 200.

The reference properties may have been predetermined manually offline by an application developer or by pattern recognition software and stored. Additionally, if a user takes inventory of an object by viewing it with the NED system 8 and inputting data in data fields, reference properties for an object can be stored in structure data 200 by the object recognition engine 192. The reference properties (e.g. structure patterns and image data) may also be accessed by applications for generating virtual objects.

For real objects, data may be assigned for each of a number of object properties 320 like 3D size, 3D shape, type of materials detected, color(s), and boundary shape detected. In one embodiment, based on a weighted probability for each detected property assigned by the object recognition engine 192 after comparison with reference properties, the object is identified and its properties stored in an object properties data set 320N. More information about the detection and tracking of objects can be found in U.S. patent application Ser. No. 12/641,788, “Motion Detection Using Depth Images,” filed on Dec. 18, 2009; and U.S. patent application Ser. No. 12/475,308, “Device for Identifying and Tracking Multiple Humans over Time,” both of which are incorporated herein by reference in their entirety.

The scene mapping engine 306 and the object recognition engine 192 exchange data which assist each engine in its functions. For example, based on an object identification and orientation determined by the object recognition engine 192, the scene mapping engine 306 can update a 3D space position or position volume for an object for more accuracy. For example, a chair on its side has different position coordinates for its volume than when it is right side up. A position history or motion path identified from position volumes updated for an object by the scene mapping engine 306 can assist the object recognition engine 192 identify an object, particularly when it is being partially occluded. The operating system 190 may facilitate communication between the various engines and applications.

The 3D audio engine 304 is a positional 3D audio engine which receives input audio data and outputs audio data for the earphones 130 or other audio output devices like speakers in other embodiments. The received input audio data may be for a virtual object or be that generated by a real object. Audio data for virtual objects generated by an application or selected from a sound library 312 can be output to the earphones to sound as if coming from the direction of the virtual object. Based on audio data as may be stored in the sound library 312 and voice data files stored in user profile data 197 or user profiles 322, sound recognition engine 194 identifies audio data from the real world received via microphone 110 for application control via voice commands and for environment and object recognition. The gesture recognition engine 193 identifies one or more gestures. A gesture is an action performed by a user indicating a control or command to an executing application. The action may be performed by a body part of a user, e.g. a hand or finger, but also an eye blink sequence of an eye can be a gesture. In one embodiment, the gesture recognition engine 193 compares a skeletal model and movements associated with it derived from the captured image data to stored gesture filters in a gesture library to identify when a user (as represented by the skeletal model) has performed one or more gestures. In some examples, matching of image data to image models of a user's hand or finger during gesture training sessions may be used rather than skeletal tracking for recognizing gestures.

An application 162 communicates data with the display data engine 195 in order for the display data engine 195 to display and update display of image data controlled by the application 166. For augmented reality, the image data may be of a virtual object or feature. Similarly for a virtual reality application, the data may represent virtual objects or virtual features. For a night vision application, the image data may be a representation of real objects detected with sensors sensitive to non-visible light or infrared light. Display data engine 195 processes data for both types of display, front and peripheral displays, and has access to the display angular resolution mappings 325 predetermined for each type of display.

Display data engine 195 registers the 3D position and orientation of objects represented by image data in relation to one or more coordinate systems, for example in view dependent coordinates or in the view independent coordinates. Additionally, the display data engine 195 performs translation, rotation, and scaling operations for display of the image data at the correct size and perspective. A position of an object being displayed may be dependent upon, a position of a corresponding object, real or virtual, to which it is registered. The display data engine 195 can update the scene mapping engine about the positions of the virtual objects processed. The display data engine 195 determines the position of image data in display coordinates for each display (e.g. 14l, 14r, 125l, 125r) based on the appropriate display angular resolution mapping 325.

The following discussion describes some example processing for updating an optical see-through, augmented reality (AR) display to position virtual objects so that they appear realistically at 3D locations determined for them in the display. A peripheral display may be an optical see-through AR display, and in some embodiments may displayed image data layered in a Z buffer as described here.

In one example implementation of updating the 3D display, a Z-buffer is used. The Z-buffer stores data for each separately addressable display location or area, like a pixel, so the Z-buffer scales with the number of its separately controllable display locations or areas, and data is assigned in the Z-buffer based on the angular resolution mapping of the display. The display data engine 195 renders, commensurate with the angular resolution mapping, the previously created three dimensional model of each type of display's field of view including depth data for both image data objects (e.g. virtual or real objects for night vision) and real objects in a Z-buffer. The real object boundaries in the Z-buffer act as references for where the image data objects are to be three dimensionally positioned in the display as the image source 120 displays the image data objects but not real objects as the NED device, in this example, is an optical see-through display device. For an image data object, the display data engine 195 has a target 3D space position of where to insert the image data object.

A depth value is stored for each display location or a subset of display locations, for example for each pixel (or for a subset of pixels). Image data corresponding to image data objects are rendered into the same z-buffer and the color information for the image data is written into a corresponding color buffer, which also scales with the number of display locations. In this embodiment, the composite image based on the z-buffer and color buffer is sent to image source 120 to be displayed by the appropriate pixels. The display update process can be performed many times per second (e.g., the refresh rate).

For a video-see, augmented reality display or operation of a see-through display in a video-see mode, image data of the real objects is also written into the Z-buffer and corresponding color buffer with the image data of virtual objects or other enhanced objects. In a video-see mode, an opacity filter of each see-through display 14 can be tuned so that light reflected from in front of the glasses does not reach the user's eye 140 and the 3D image data of both the real and virtual or enhanced objects is played on the display.

Device data 198 may include an identifier for the personal apparatus 8, a network address, e.g. an IP address, model number, configuration parameters such as devices installed, identification of the operating system, and what applications are available in the NED system 8 and are executing in the NED system 8 etc. Additionally, in this embodiment, the display angular resolution mappings 325 for the front and peripheral displays are stored. Particularly for the see-through, augmented reality NED system 8, the device data may also include data from sensors or sensing units or determined from the sensors or sensing units like the orientation sensors in inertial sensing unit 132, the microphone 110, and the one or more location and proximity transceivers in location sensing unit 144.

User profile data, in a local copy 197 or stored in a cloud based user profile 322 has data for user permissions for sharing or accessing of user profile data and other data detected for the user like location tracking, objects identified which the user has gazed at if eye tracking is implemented, and biometric data. Besides personal information typically contained in user profile data like an address and a name, physical characteristics for a user are stored as well. As discussed in more detail below, physical characteristics include data such as physical dimensions some examples of which are height and weight, width, distance between shoulders, leg and arm lengths and the like.

The technology may be embodied in other specific forms without departing from the spirit or essential characteristics thereof. Likewise, the particular naming and division of modules, routines, applications, features, attributes, methodologies and other aspects are not mandatory, and the mechanisms that implement the technology or its features may have different names, divisions and/or formats.

For illustrative purposes, the method embodiments below are described in the context of the system and apparatus embodiments described above. However, the method embodiments are not limited to operating in the system embodiments described above and may be implemented in other system embodiments. Furthermore, the method embodiments may be continuously performed while the NED system is in operation and an applicable application is executing.

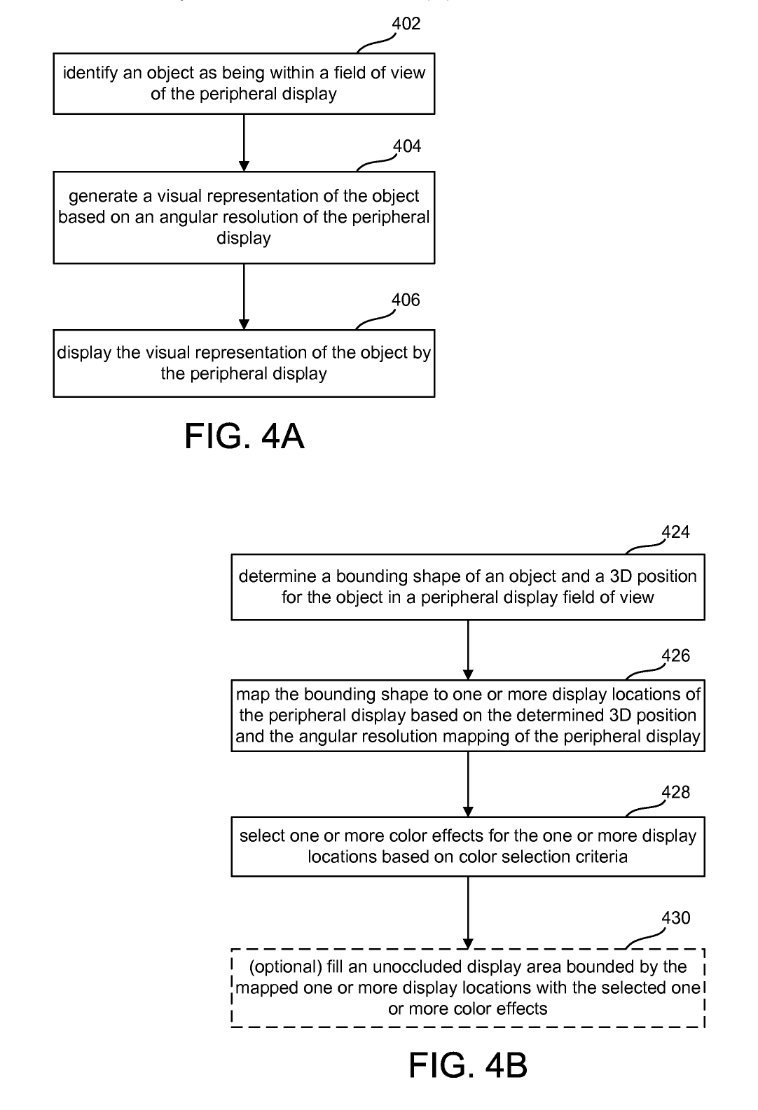

FIG. 4A is a flowchart of an embodiment of a method for indicating an object on a peripheral display of a near-eye display device. As in the example of FIG. 2A, portions of the same object may be in both the front and peripheral displays. For example, a large virtual dragon may be in the field of view of the front display and also in a peripheral field of view. In some examples, the scene mapping engine 306 and the display data engine 195 may treat the different portions as separate objects.

In step 402, the scene mapping engine 306 identifies an object as being within a field of view of the peripheral display. In step 404, the display data engine generates a visual representation of the object based on an angular resolution of the peripheral display, and in step 406, displays the visual representation of the object by the peripheral display. As discussed below, in some examples, the peripheral display 125 may be embodied as just a few pixels like a line of photodiodes (e.g. light emitting diodes). The object on the peripheral display may be visually represented simply by its color or a predominant color associated with the object. Even a line of photodiodes can have a mapping of the field of view to each photodiode. For example, each of five photodiodes can represent about a twenty (20) degree slice of a total peripheral field of view of about 100 degrees. As the object moves across the field of view, its direction of motion is visually represented by which photodiode is lit, and its speed by how fast the each photodiode turns on and off.

FIG. 4B is a flowchart of a process example for generating a visual representation of an object based on an angular resolution of the peripheral display. As mentioned above, the scene mapping engine 306 may represent the position of an object in a 3D mapping of a display field of view, if not a user environment, as a position of a bounding shape. In this process example, the bounding shape is mapped to the peripheral display to save processing time. In step 424, the scene mapping engine 306 determines a bounding shape of an object and a 3D position for the object in a peripheral display field of view. The display data engine 195 maps in step 426 the bounding shape to one or more display locations of the peripheral display based on the determined 3D position and the angular resolution mapping of the peripheral display.

In step 428, one or more color effects are selected for the object based on color selection criteria. Some examples of color selection criteria are one or more colors of the object, a predetermined color code for indicating motion to or away from the peripheral display, and hence the user's side, or a predetermined color scheme for identifying types of objects, e.g. enemy or friendly. Another color effect which may be selected is a shadow effect. Optionally, in step 430, the one or more colors may be selected for the bounding shape but also for filling an unoccluded display area bounded by the mapped one or more display locations with the selected one or more color effects. Portions of an image data object, including portions of its boundary shape, may be occluded by other objects, real or virtual, so that occluded portions may not be displayed or are colored with a color for an occluding object.

In some examples, the scene mapping engine 306 receives data (e.g. from other NED systems 8, 3D image capture devices 20 in an environment, or a centrally updated map from a network accessible computer system 12) for updating the tracking of objects in an environment, even objects outside a field of view of either type of display or even both. A shadow effect may also be used to indicate an object just outside a display field of view.

Below are described some embodiments of peripheral displays which are practical in view of space, weight, cost and feasibility for manufacturing.

FIG. 5A is a block diagram illustrating an embodiment of a peripheral display using optical elements. The peripheral display is shown in relation to a block diagram of representative elements processing light for an embodiment of a front display like in FIG. 1. These representative elements include image source 120 which generates light representing the image data, a collimating lens 122 for making light from the image source appear to come from infinity, and a light guide optical element 112 which reflects the light representing image data from the image source 120 towards an eye area in which the light is likely to fall onto a retina 143 of an eye 140 if a user is wearing the NED device 2. In this embodiment, the peripheral display is a projection peripheral display which comprises a reflecting element 224 optically coupled to the image source 120 for receiving image data, and the reflecting element 224 directs the received image data towards the eye area but from a side angle for the purpose of falling onto a user's retina 143 as well. The received peripheral image data is represented by a portion of the image source output. For example, if the image source 120 is a microdisplay which defines its display area in pixels, than a subset of the pixels, for example a subset located along the right edge of the microdisplay 120 for this right side peripheral display, provides the image data for the peripheral display, hereafter referred to as the peripheral image data. For example, for a microdisplay of 720 pixels or a megapixel, assuming a rectangular or square shape, the peripheral image data may be displayed in columns including the rightmost pixels of 20, 50 or even a 100 pixels for the right side peripheral display. In the left side peripheral display case, the peripheral image data is displayed on a subset of leftmost pixels for this example. Some examples of optical elements optically coupling the reflecting element 224 including an optical element 220, for example a piece of plastic or glass, acting as a prism for directing light through a collimating lens 222 onto the reflecting element 224.

FIG. 5B is a block diagram illustrating another embodiment of a projection peripheral display using a waveguide 230. Some examples of technology which may be used in implementing a waveguide are reflective, refractive, or diffractive technologies or a combination of any of these. Like the embodiment of FIG. 5A, the waveguide 230 is optically coupled to receive a subset of image data from the image source 120 as peripheral image data. The peripheral image light data is optically coupled from the waveguide 230 towards an eye area selected for a likelihood of the light data falling on a retina 143 of a right eye in this example of a right side peripheral display.

The optical coupling mechanism 232 directs the light from the image source 120 into the waveguide 230, for example by any of reflection, refraction, and diffraction or a combination thereof. In some examples, the input optical coupling mechanism 232 may include one or more optical elements incorporating lens power and prismatic power thus eliminating the use of a separate collimating lens. In other examples, the input optical coupling mechanism 232 may have lens power as a separate component on a front surface receiving the subset of light from the image source for the peripheral display and prismatic power on a back surface directing light into the waveguide. Similarly, the optical coupling mechanism 234 directs light out of the waveguide 230. The one or more optical elements making up each mechanism may generate a hologram. In some examples, the optical power of the output optical coupling mechanism 234 is a simple wedge having diffractive power. If desired, lens power may be incorporated as well in the output optical coupling mechanism 234.

An example of a low cost implementation technology which may be used for each optical coupling mechanism 232, 234 is a Fresnel structure. For example, a reflective Fresnel structure may be used. Although a Fresnel structure may not be a suitable optical element for satisfying good image quality criteria for a front display, a Fresnel optical element, e.g. made of plastic, is a suitable low cost element for use with a lower resolution peripheral display.

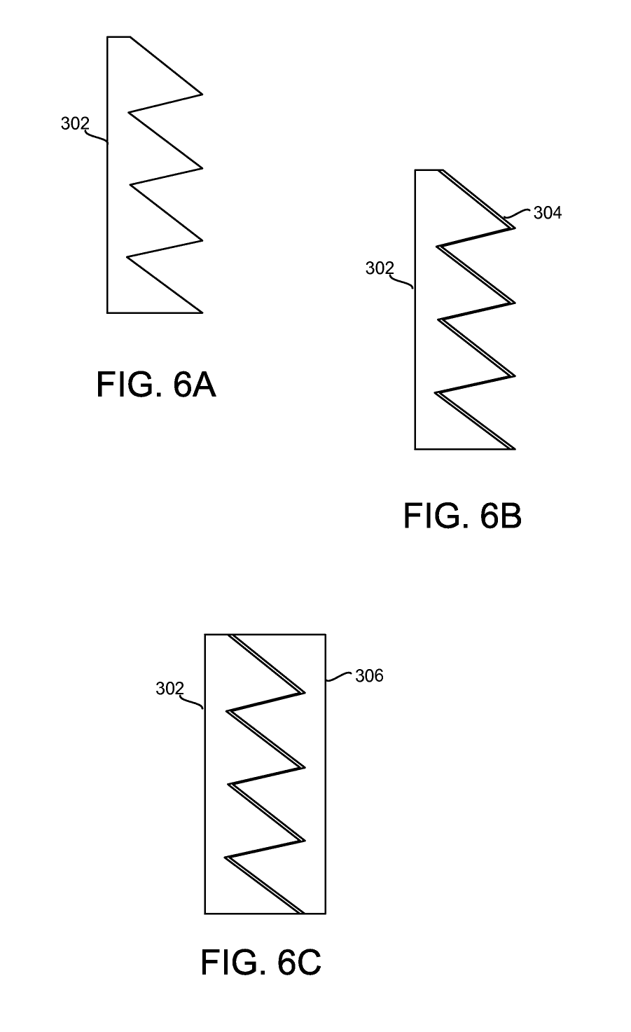

One or more of the optical coupling mechanisms may be embedded in the waveguide. For example, output optical coupling mechanism 234 may be an embedded reflective Fresnel structure. FIGS. 6A, 6B and 6C illustrate different stages in an overview example of making an embedded Fresnel structure for use with a peripheral display like a waveguide display. As shown in FIG. 6A, a Fresnel structure 302 is formed. In FIG. 6B, its reflective surface is coated with a partially reflecting coating 304 such that light that is not reflected to the eyes will continue to be guided down the substrate of the waveguide. Index matching adhesive 306 fills the Fresnel from its coated reflective surface in FIG. 6C. Such a simple stamping manufacturing process is feasible and cheap, thus making peripheral displays practical.

In some embodiments, a peripheral display may have its own image source. For example, the embodiments in FIGS. 5A and 5B may be altered to have a separate image source for each peripheral display.

FIG. 5C is a block diagram illustrating an embodiment of a peripheral projection display using a wedge optical element 235 coupled via one or more optical elements represented by representative lens 236 for receiving a subset of the image data from image source 120. The wedge optical element 235 acts as a total internal reflection light guide which magnifies an image and acts as a projection display. Light injected at different angles into the wedge, in this example at the wider bottom, reflect out of the wedge at different angles thus providing the ability for representing objects in three dimensions. Certain wedge optical elements, for example ones used in Microsoft Wedge products, are very thin and thus are good for compact display devices like a NED device.

FIG. 5D is a block diagram illustrating an embodiment of a peripheral projection display using a wedge optical element and its own separate image source of a projector 263 which would be controlled by the one or more processors of a NED display device to generate image data for display via the wedge optical element 235.

FIG. 5E is a block diagram illustrating another embodiment of a peripheral display as a projection display. This embodiment employs a small projection engine including a pico projector 250 and a projection screen 254. In this embodiment, the peripheral display includes a shallow total internal reflection (TIR) fold mechanism for directing light to the screen. In some examples, the projection screen could have a Fresnel structure or a diffractive structure for pushing light towards the user's eye. As in FIG. 5D, another example of technology for implementing such a TIR fold mechanism is a wedge projection display.

In some embodiments, another example of a small projection engine may be one which uses a scanning mirror for directing color controlled output from light sources, e.g. lasers, to a projection surface, either in one dimension at a time, e.g. row by row, or in two-dimensions for creating an image on the projection surface which then may be optically directed towards the user's eye. The scanning mirror may be implemented using microelectromechanical system (MEMS) technology. An example of a pico projection engine using MEMS technology is Microvision's PicoP® Display Engine.

The above embodiments in FIGS. 5A through 5D illustrate some examples of technologies which may be used to implement a peripheral display as an optical see-through peripheral display. If the screen in FIG. 5E is transparent, the embodiment in FIG. 5E may also be used for an optical see-through peripheral display.

In addition to the embodiments of projection peripheral displays, FIGS. 5F and 5G illustrate some embodiments of direct view peripheral displays. These embodiments provide some examples of peripheral displays in which the front display image source is not used. FIG. 5F is a block diagram illustrating an embodiment of a peripheral display as a direct view image source 240. An example of an image source 240 is a small display which displays images. It may just be a small number of pixels, for example about 20. Some examples of implementing technology include a liquid crystal display (LCD) and an emissive display such as an OLED or iLED, which may be transparent or non-transparent. As the peripheral display 240 is positioned on a side of the NED device which would be to the side of the eye of a wearer and the display 240 is positioned close to the user's head, for example within a side arm 102 of the NED device, a user cannot focus on the display, and thus cannot resolve image details of structure. However, the display can display color, shadow and indicate movement by activating and de-activating a sequence of separately controllable display areas or locations, for example pixels or sub-pixels, on the display. The display 240 may also be a diffuse reflecting display so more light may be directed from the display in a direction approximating a position of a user's retina 143.

If a line extending from between a human's two eyes is a center axis, an object becomes more and more physically uncomfortable to view the more it is at an angle farther from the center axis. When a human “sees something out of the corner of his eye,” he naturally moves his head to get a better view of the “something” and avoid discomfort. Taking advantage of this natural human reaction, can provide a very simple form of peripheral display.

FIG. 5G is a block diagram illustrating an embodiment of a peripheral display as one or more photodiodes 247. A single photodiode is labeled to avoid overcrowding the drawing. An example of photodiodes which may be used are light emitting diodes (LEDs). For purposes of providing situational awareness like an impending virtual helicopter on course to crash into a user like in the example of FIG. 2A, a visual indicator such as a lit up LED may be a visual representation indicating a presence of image data representing an object. In applications, like night vision goggles, an LED lit in green may indicate to a wearer that something is moving toward him from his right and an LED lit in blue may indicate something is moving away from him to his right. The wearer may decide to look to his right. In another example, there may be a row of photodiodes as in the drawing, and each photodiode covers an angular area in the peripheral field of view. Each photodiode may have an associated color, so display of the color associated with a photodiode provides an indication of where the object is in the peripheral field of view. Additionally, a speed of flashing the photodiode may indicate the peripheral object or objects in the angular area are moving closer or farther away from the wearer of the NED.

In these examples, the visual representation on the peripheral display does not interfere with the image data displayed on the front display. This is helpful for applications such as a navigation application. Visual representations, for example a photodiode displaying red on the peripheral display on the side of the device corresponding to a direction in which a turn is to be made, can represent directions without interfering with the driver's front view.

FIG. 7 is a block diagram of one embodiment of a computing system that can be used to implement a network accessible computing system 12, a companion processing module 4, or another embodiment of control circuitry 136 of a near-eye display (NED) device which may host at least some of the software components of computing environment 54 depicted in FIG. 3. With reference to FIG. 7, an exemplary system includes a computing device, such as computing device 900. In its most basic configuration, computing device 900 typically includes one or more processing units 902 including one or more central processing units (CPU) and one or more graphics processing units (GPU). Computing device 900 also includes memory 904. Depending on the exact configuration and type of computing device, memory 904 may include volatile memory 905 (such as RAM), non-volatile memory 907 (such as ROM, flash memory, etc.) or some combination of the two. This most basic configuration is illustrated in FIG. 7 by dashed line 906. Additionally, device 900 may also have additional features/functionality. For example, device 900 may also include additional storage (removable and/or non-removable) including, but not limited to, magnetic or optical disks or tape. Such additional storage is illustrated in FIG. 7 by removable storage 908 and non-removable storage 910.

Device 900 may also contain communications connection(s) 912 such as one or more network interfaces and transceivers that allow the device to communicate with other devices. Device 900 may also have input device(s) 914 such as keyboard, mouse, pen, voice input device, touch input device, etc. Output device(s) 916 such as a display, speakers, printer, etc. may also be included. These devices are well known in the art so they are not discussed at length here.

The example computer systems illustrated in the figures include examples of computer readable storage devices. A computer readable storage device is also a processor readable storage device. Such devices may include volatile and nonvolatile, removable and non-removable memory devices implemented in any method or technology for storage of information such as computer readable instructions, data structures, program modules or other data. Some examples of processor or computer readable storage devices are RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other device which can be used to store the information and which can be accessed by a computer.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A peripheral display for use with a near-eye display device comprising:
a peripheral display positioned by a near-eye support structure of a near-eye display device for directing a visual representation of an object in a peripheral field of view associated with the peripheral display towards a side of an eye area associated with the near-eye display device; and
the peripheral display having a lower angular resolution than an angular resolution of a front display positioned by the support structure in front of an eye area associated with the near-eye display device.

2. The peripheral display of claim 1 wherein the peripheral display comprises a direct view display communicatively coupled to one or more processors of the near-eye display device for receiving the visual representation of the object in the peripheral field of view.

3. The peripheral display of claim 1 wherein the peripheral display comprises a projection display.

4. The peripheral display of claim 1 wherein the peripheral display comprises
a reflecting element optically coupled for receiving from an image source the visual representation of the object; and
the reflecting element being positioned to reflect the visual representation of the object towards the side of the eye area associated with the near-eye display device.

5. The peripheral display of claim 4 wherein the reflecting element is a wedge optical element.

6. The peripheral display of claim 4 wherein the reflecting element comprises a scanning mirror.

7. The peripheral display of claim 1 wherein the peripheral display comprises a waveguide display including a waveguide, an optical element for coupling the visual representation of the object into the waveguide, and an optical element for coupling the visual representation of the object out of the waveguide and directing the visual representation toward the side of the eye area associated with the near-eye display device; and
at least one of the input optical element or the output optical element is a reflective Fresnel structure.

8. The peripheral display of claim 1 wherein the peripheral display comprises a projection screen including a Fresnel structure positioned by the near-eye support structure for directing the visual representation towards the side of the eye area, the projection screen being optically coupled to a total internal reflection (TIR) fold mechanism for receiving the visual representation from a projector.

9. A near-eye display device comprising:
a near-eye support structure;
a front display positioned by the near-eye support structure to be in front of an eye area associated with the near-eye display device;
at least one peripheral display having a lower display resolution than the front display and the at least one peripheral display being positioned by the near-eye support structure at a side position to the front display;
an image source optically coupled to the peripheral display; and
one or more processors communicatively coupled to the image source for controlling image data displayed by the at least one peripheral display.

10. The near-eye display device of claim 9 further comprising
the near-eye support structure includes a side arm which positions the at least one peripheral display at the side position to the front display.

11. The near-eye display device of claim 9 further comprising:
the at least one peripheral display is an optical see-through display.

12. The near-eye display device of claim 9 further comprising the lower display resolution of the at least one peripheral display decreases with distance from the front display.

13. The near-eye display device of claim 9 further comprising a separate image source optically coupled to the front display, and the one or more processors communicatively coupled to the separate image source for the front display for controlling image data displayed by the front display.

14. The near-eye display device of claim 9 wherein the image source optically coupled to the peripheral display is also optically coupled to the front display;
the image source providing front image data for the front display and peripheral image data for the peripheral display.

15. The near-eye display device of claim 14 wherein the image source further comprises a microdisplay for displaying front image data and peripheral image data at a same time.

16. The near-eye display device of claim 9 wherein the peripheral display further comprises a Fresnel structure positioned for directing image data towards a side of an eye area associated with the near-eye display device, the image data representing an object in a field of view of the peripheral display.

17. A method for indicating an object on a peripheral display of a near-eye display device comprising:
identifying the object as being within a field of view of the peripheral display which is positioned at a side position relative to a front display of the near-eye display device;
generating a visual representation of the object based on an angular resolution of the peripheral display, which angular resolution is lower than an angular resolution of the front display; and
displaying the visual representation of the object by the peripheral display.

18. The method of claim 17 wherein generating a visual representation of the object based on an angular resolution of the peripheral display further comprises:
determining a bounding shape of the object and a three dimensional (3D) position for the object in a peripheral display field of view;
mapping the bounding shape to one or more display locations of the peripheral display based on the 3D position and an angular resolution mapping of the peripheral display; and
selecting one or more color effects for the one or more display locations based on color selection criteria.

19. The method of claim 18 wherein the color selection criteria comprises at least one of the following:
one or more colors of the object;
a predetermined color code for indicating motion to or away from the peripheral display; or
a predetermined color scheme for identifying types of objects.

20. The method of claim 18 further comprising:
filling an unoccluded display area bounded by the one or more display locations with the one or more color effects.
